(19) United States
(12) Patent Application Publication
(10) Pub. No.: US 2024/0100472 A1
(43) Pub. Date: Mar. 28, 2024

(54) PROCESS AND PLANT FOR PRODUCING HYDROGEN-RICH SYNTHESIS GAS STREAM FROM A CARBON-CONTAINING INPUT GAS STREAM

(71) Applicant: L'Air Liquide, Société Anonyme Pour I'Etude et I'Exploitation des Procédés Georges Claude, Paris (FR)

(72) Inventor: Sophia SCHMIDT, Frankfurt am Main (DE)

(21) Appl. No.: 18/372,517

(22) Filed: Sep. 25, 2023

(30) Foreign Application Priority Data
Sep. 26, 2022 (EP) 22197678.0

(51) Int. Cl. B01D 53/14; B01D 53/18; C01B 3/38; C01B 3/48; C01B 3/52

(52) U.S. Cl. CPC B01D 53/1475; B01D 53/1425; B01D 53/18; C01B 3/38; C01B 3/48; C01B 3/52; B01D 2257/504; C01B 2203/0233; C01B 2203/0244; C01B 2203/0255; C01B 2203/0261; C01B 2203/0283; C01B 2203/0415; C01B 2203/0475; C01B 2203/068; C01B 2203/0872; C01B 2203/1241; C01B 2203/148

(57) ABSTRACT

Provided is a process for producing a hydrogen-rich synthesis gas stream having reduced carbon dioxide emission by reacting a carbon-containing input gas stream in at least one synthesis gas production stage to produce a raw synthesis gas steam, producing a converted synthesis gas stream by converting the cooled raw synthesis gas steam in a CO conversion plant which includes at least one CO conversion stage, contacting the cooled converted synthesis gas stream in a carbon dioxide absorption column and discharging a first synthesis gas stream and utilizing at least a portion of the second synthesis gas stream depleted in carbon dioxide as a portion of fuel gas or process gas or forms the fuel gas or process gas.

### CROSS REFERENCE TO RELATED APPLICATIONS

This application claims the benefit of priority under 35 U.S.C. § 119(a) and (b) to European Patent Application No. 22197678.0, filed Sep. 26, 2022, the entire contents of which are incorporated herein by reference.

### TECHNICAL FIELD

The invention relates generally to synthesis gas production; more specifically, the invention relates to a process and a plant for producing a hydrogen-rich synthesis gas stream from a carbon-containing input gas stream having reduced carbon dioxide emission from reforming by using hydrogen fueling. The process and plant advantageously use less energy for purification of hydrogen in a purification unit.

### BACKGROUND

Carbon gases released during current methods of ammonia production contribute to global carbon emission, which is the biggest threat to global warming. Hence, it is required to minimize the carbon gas emissions from ammonia production plants. It is also important that the reduction of emissions should not increase the costs of production of ammonia. EP3583067 B1 presents a setup, in which the hydrogen coming from a gas-cleaning unit is split into two streams: One stream is sent to further purification prior to ammonia synthesis, and the other stream is sent to a reforming unit for fueling. The effect of the usage of hydrogen is to decrease the carbon emissions in the flue gas, as less natural gas is required for firing, which is combusted to carbon dioxide (CO₂). The obvious disadvantage of the prior art is that a large amount (e.g., ˜33% of the CO₂-depleted hydrogen) is used for fueling. This hydrogen has to be processed in the gas-cleaning unit and creates a high amount of utility consumption, especially a high amount of energy consumption, which should be prevented. The amount of hydrogen used for fueling depends on a reforming technology as well as on the required carbon footprint or avoidance and can vary between a couple of percent of the produced hydrogen to the 33% of the example from the mentioned prior art.

Therefore, there is a need to address the aforementioned technical drawbacks in existing known technologies to decrease the carbon emissions in hydrogen production via a natural gas reforming but, at the same time, reduce the energy consumption.

### SUMMARY

The invention seeks to provide an improved approach to decrease carbon emissions from reforming by using hydrogen fueling without using high energy for purification of hydrogen in a gas-cleaning unit or a carbon dioxide absorption column. An aim of the invention is to provide a solution that overcomes, at least partially, the problems encountered in prior art and provide a process and a plant for producing a hydrogen-rich synthesis gas stream from a carbon-containing input gas stream having reduced carbon dioxide emission by using a portion of synthesis gas stream from the carbon dioxide absorption column as a fuel gas in a synthesis gas production stage. The portion of synthesis gas stream is withdrawn between a fine scrubbing and a main scrubbing section of the carbon dioxide absorption column and used as hydrogen fuel within the reforming section, thereby solvent requirement for the fine scrubbing section is reduced which in turn leads to savings in utility consumption and capital expenditures. Further, the invention provides a hydrogen-fueling concept for blue ammonia production where a final carbon dioxide depleted stream after a purifying, conditioning or processing step is sent along with nitrogen to an ammonia synthesis unit.

The object of the invention is achieved by the solutions provided in the enclosed independent claims. Advantageous implementations of the invention are further defined in the enclosed dependent claims.

According to a first aspect, the invention provides a process for producing a hydrogen-rich synthesis gas stream from a carbon-containing input gas stream having reduced carbon dioxide emission, comprising the steps of:
(a) providing a sulfur-free or desulfurized, carbon-containing input gas stream;
(b) introducing the input gas stream, preferably the sulfur-free or desulfurized input gas, into at least one synthesis gas production stage, selected from a group comprising steam reforming stage, gas-heated reforming stage (GHR), autothermal reforming stage (ATR), catalytic partial oxidation stage (CPOX), noncatalytic partial oxidation stage (POX);
(c) converting the carbon-containing input gas stream introduced into the at least one synthesis gas production stage under synthesis gas production conditions and discharging a raw synthesis gas stream containing hydrogen, carbon monoxide and carbon dioxide from the at least one synthesis gas production stage;
(d) introducing the raw synthesis gas stream into a first cooling apparatus, cooling the raw synthesis gas stream in the first cooling apparatus, discharging the cooled raw synthesis gas stream from the first cooling apparatus;
(e) introducing the cooled raw synthesis gas stream into a CO conversion plant comprising at least one CO conversion stage, converting the cooled raw synthesis gas stream introduced into the CO conversion plant under CO conversion conditions to afford a converted synthesis gas stream, discharging the converted synthesis gas stream which is enriched in hydrogen and carbon dioxide and depleted in carbon monoxide relative to the raw synthesis gas stream;
(f) introducing the converted synthesis gas stream into a second cooling apparatus, cooling the converted the synthesis gas stream in the second cooling apparatus, discharging the cooled converted synthesis gas stream from the second cooling apparatus;
(g) introducing the cooled converted synthesis gas stream into a carbon dioxide absorption column, which operates according to the principle of a gas scrubbing having a physical or chemical scrubbing medium, wherein the carbon dioxide absorption column comprises:
   (g1) at least one mass transfer zone, in the form of a structured packing and/or a random packing and/or a tray column,
   (g2) an inlet for the cooled converted synthesis gas stream,
   (g3) an outlet for a first synthesis gas stream depleted in carbon dioxide at the upper end of the absorption column,
   (g4) an outlet for a scrubbing medium stream enriched in carbon dioxide at the lower end of the absorption column,
   (g5) an inlet for a fine scrubbing medium stream in the upper region of the absorption column, wherein the fine scrubbing medium stream is obtained by hot regeneration of at least a portion of the scrubbing medium stream enriched in carbon dioxide,
   (g6) an inlet for a main scrubbing medium stream arranged in the upper region of the absorption column but below the inlet for the fine scrubbing medium stream, wherein the main scrubbing medium stream is obtained by flash regeneration of at least a portion of the scrubbing medium stream enriched in carbon dioxide to obtain at least one flash gas stream whose carbon dioxide concentration is higher than that in the first synthesis gas stream depleted in carbon dioxide;
(h) contacting the cooled converted synthesis gas stream in the carbon dioxide absorption column with the main scrubbing medium stream and with the fine scrubbing medium stream, discharging the first synthesis gas stream depleted in carbon dioxide as a hydrogen-rich synthesis gas stream at the upper end of the absorption column;
(i) optionally supplying the hydrogen-rich synthesis gas stream to at least one further purifying, conditioning or processing step;
characterized in that
(j) the carbon dioxide absorption column comprises a further outlet which is arranged below the inlet for the fine scrubbing medium stream as a side draw and by means of which a second synthesis gas stream depleted in carbon dioxide, whose carbon dioxide concentration is higher than that in the first synthesis gas stream depleted in carbon dioxide, is discharged;
(k) wherein at least a portion of the second synthesis gas stream depleted in carbon dioxide is utilized as a portion of a fuel gas or process gas or forms the fuel gas or process gas.

The process for producing the hydrogen-rich synthesis gas stream from the carbon-containing input gas stream according to the invention is of advantage in that the process decreases the carbon dioxide emissions from reforming by using hydrogen fueling without consuming a high amount of energy for the purification of the hydrogen in the gas cleaning unit. The process includes withdrawing the hydrogen rich fuel gas stream between the fine scrubbing and the main scrubbing section of the carbon dioxide absorption column and using as hydrogen fuel within the reforming section through which the solvent requirement for the fine scrubbing section is reduced which in turn enables savings in electrical and low-pressure steam consumption, and enables decreasing diameters of both carbon dioxide absorption column and regenerator slightly. The process of the invention includes flash regeneration of the scrubbing media stream from the carbon dioxide absorption column to obtain the main scrubbing medium stream, where the regeneration is done by flashing (pressure decrease) and consumes only a minimum energy for re-compression of the solvent. During flashing, CO₂ is removed from the solvent and the so-called auto-refrigeration effect causes a decrease in the temperature of the system, which is beneficial for absorption efficiency. The process of the invention includes hot regeneration of the scrubbing media stream from the carbon dioxide absorption column to obtain the fine scrubbing medium stream. In the fine scrubbing section, at least a part of the cooled methanol from the hot regeneration unit is used for absorption. The regeneration of this type of solvent requires more energy and additional equipment than the solvent regenerated by flashing only. Therefore, reducing this type of solvent leads to savings in utility consumption and capital expenditures.

According to a second aspect, the invention provides a plant for producing a hydrogen-rich synthesis gas stream from a carbon-containing input gas stream having reduced carbon dioxide emission, comprising the following assemblies and constituents fluidically connected to one another:
(a) means for providing a sulfur-free or desulfurized, carbon-containing input gas stream;
(b) at least one synthesis gas production stage selected from a group comprising:
   steam reforming stage, gas-heated reforming stage (GHR), autothermal reforming stage (ATR), catalytic partial oxidation stage (CPOX), noncatalytic partial oxidation stage (POX);
   means for introducing the input gas stream, preferably the sulfur-free or desulfurized input gas stream, into the at least one synthesis gas production stage;
(c) means for discharging a raw synthesis gas stream containing hydrogen, carbon monoxide (CO) and carbon dioxide (CO₂) from the at least one synthesis gas production stage;
(d) a first cooling apparatus, means for discharging the raw synthesis gas stream into the first cooling apparatus means for discharging a cooled raw synthesis gas stream from the cooling apparatus;
(e) a CO conversion plant comprising at least one CO conversion stage, means for introducing the cooled raw synthesis gas stream into the CO conversion plant, means for discharging a converted synthesis gas stream which is enriched in hydrogen and carbon dioxide and depleted in carbon monoxide relative to the raw synthesis gas stream;
(f) a second cooling apparatus, means for introducing the converted synthesis gas stream into the second cooling apparatus, means for discharging a cooled converted synthesis gas stream from the second cooling apparatus;
(g) a carbon dioxide absorption column which operates according to the principle of a gas scrubbing having a physical or chemical scrubbing medium, wherein the carbon dioxide absorption column comprises:
   (g1) at least one mass transfer zone in the form of a structured packing and/or a random packing and/or or a tray column,
   (g2) an inlet for the cooled converted synthesis gas stream,
   (g3) an outlet for a first synthesis gas stream depleted in carbon dioxide at the upper end of the absorption column,
   (g4) an outlet for a scrubbing medium stream enriched in carbon dioxide at the lower end of the absorption column,
   (g5) an inlet for a fine scrubbing medium stream in the upper region of the absorption column, wherein the fine scrubbing medium stream is obtained by hot regeneration of at least a portion of the scrubbing medium stream enriched in carbon dioxide,
   (g6) an inlet for a main scrubbing medium stream arranged in the upper region of the absorption column but below the inlet for the fine scrubbing medium stream, wherein the main scrubbing medium stream is obtained by flash regeneration of at least a portion of the scrubbing medium stream enriched in carbon dioxide, wherein at least one flash gas stream whose carbon dioxide concentration is higher than that in the first synthesis gas stream depleted in carbon dioxide is obtained, means for introducing the cooled converted synthesis gas stream into the carbon dioxide absorption column;
(h) means for discharging the first synthesis gas stream depleted in carbon dioxide as a hydrogen-rich synthesis gas stream at the upper end of the absorption column;
(i) optionally: means for supplying the hydrogen-rich synthesis gas stream to at least a further purification, conditioning or processing apparatus;
characterized in that
(j) the carbon dioxide absorption column comprises a further outlet which is arranged below the inlet for the fine scrubbing medium stream as a side draw and by means of which a second synthesis gas stream depleted in carbon dioxide, whose carbon dioxide concentration is higher than that in the first synthesis gas stream depleted in carbon dioxide, may be discharged;
(k) wherein means which allow at least a portion of the second synthesis gas stream depleted in carbon dioxide to be utilized as a portion of a fuel gas or process gas or to form the fuel gas or process gas are comprised.

The plant for producing the hydrogen-rich synthesis gas stream from the carbon-containing input gas stream having reduced carbon dioxide emission according to the invention is of advantage in that the plant decreases the carbon emissions from reforming by using hydrogen fueling without consuming a high amount of energy for the purification of the hydrogen in the gas-cleaning unit. The hydrogen rich fuel gas stream is withdrawn between the fine scrubbing and the main scrubbing section of the carbon dioxide absorption column and uses it as hydrogen fuel within the reforming section through which the solvent requirement for the fine scrubbing section is reduced which in turn enables savings in electrical and low-pressure steam consumption, and enables decreasing diameters of both carbon dioxide absorption column and regenerator slightly. Flash regeneration of the scrubbing media stream from the carbon dioxide absorption column is performed to obtain the main scrubbing medium stream, where the regeneration is done by flashing (pressure decrease) and consumes only a minimum energy for re-compression of the solvent. During flashing, CO₂ is removed from the solvent and the so-called auto-refrigeration effect causes a decrease in the temperature of the system, which is beneficial for absorption efficiency. Hot regeneration of the scrubbing media stream from the carbon dioxide absorption column is performed to obtain the fine scrubbing medium stream. In the fine scrubbing section, a stream of cooled methanol from the hot regeneration unit is used for absorption. The regeneration of this type of solvent requires more energy and additional equipment than the solvent regenerated by flashing only. Therefore, reducing this type of solvent leads to savings in utility consumption and capital expenditures.

Embodiments of the invention eliminate the aforementioned drawbacks in existing known approaches by decreasing the carbon emissions from reforming by using a portion of the synthesis gas stream from the carbon dioxide absorption column as a fuel hydrogen without using high energy for the purification of hydrogen in the gas-cleaning unit.

Additional aspects, advantages, features and objects of the invention are made apparent from the drawings and the detailed description of the illustrative embodiments construed in conjunction with the appended claims that follow. It will be appreciated that features of the invention are susceptible to being combined in various combinations without departing from the scope of the invention as defined by the appended claims.

### BRIEF DESCRIPTION OF THE DRAWINGS

The summary above, as well as the following detailed description of illustrative embodiments, is better understood when read in conjunction with the appended drawings. To illustrate the present disclosure, exemplary constructions of the disclosure are shown in the drawings. However, the invention is not limited to specific methods and instrumentalities disclosed herein. Moreover, those in the art will understand that the drawings are not to scale. Wherever possible, the same elements have been indicated by identical numbers. Embodiments of the invention will now be described, by way of example only, with reference to the following diagrams wherein:

FIG. 1 is a block diagram of a prior art plant for producing hydrogen-rich synthesis gas stream from a carbon-containing input gas stream;

FIG. 2 is a block diagram of a plant for producing hydrogen-rich synthesis gas stream from a carbon-containing input gas stream having reduced carbon dioxide emission by utilizing at least a portion of a second synthesis gas stream depleted in carbon dioxide as a portion of a fuel gas or process gas or forms the fuel gas or process gas in a synthesis gas production stage according to an embodiment of the present disclosure;

FIG. 3 is a block diagram of a plant for producing hydrogen-rich synthesis gas stream from a carbon-containing input gas stream having reduced carbon dioxide emission by utilizing at least a portion of a second synthesis gas stream depleted in carbon dioxide in addition with at least a portion of at least one flash gas stream as a portion of a fuel gas or process gas or forms the fuel gas or process gas in a synthesis gas production stage according to an embodiment of the present disclosure.

### DETAILED DESCRIPTION OF PREFERRED EMBODIMENTS

The following detailed description illustrates embodiments of the invention and ways in which they can be implemented. Although some modes of carrying out the invention have been disclosed, those skilled in the art would recognize that other embodiments for carrying out or practicing the invention are also possible.

As used herein, several terms are defined below:

Synthesis gas production conditions, for example steam reforming conditions or autothermal reforming (ATR) conditions, and carbon monoxide (CO) shift conversion conditions (CO conversion conditions) are known to those skilled in the art from the prior art. These are the physicochemical conditions under which a measurable, preferably industrially relevant, conversion of hydrocarbons to synthesis gas products is achieved. For example, in a context of steam reforming, important parameters include adjustment of a suitable steam reforming entry temperature of typically about 1000° C. and addition of steam to an input gas containing hydrocarbons and thus adjustment of a steam/carbon ratio (S/C ratio). Typical values for the S/C ratio are between 0.6 and 3.0 mol/mol. Typical steam-reforming inlet temperatures are up to 700° C. and typically, the temperature range for autothermal reforming is between 950 and 1050° C. Necessary adjustments of these conditions to the respective operational requirements will be made by those skilled in the art on the basis of routine experiments, depending on the specific synthesis gas production stage or stages. Any specific reaction conditions disclosed may serve here as a guide, but they should not be regarded as limiting in relation to the scope of the invention.

Pressures, if any, are reported in absolute pressure units, bara for short, or in gauge pressure units, barg for short, unless otherwise stated in the particular individual context.

A fluid or fluidical connection between two regions of an apparatus or a plant according to the invention is to be understood as meaning any type of connection whatsoever which makes it possible for a fluid, for example a gas stream, to flow from one to the other of the two regions, neglecting any interposed regions or components. In particular, a direct fluid connection is to be understood as meaning any type of connection whatsoever which makes it possible for a fluid, for example a gas stream, to flow directly from one to the other of the two regions, wherein no further regions or components are interposed with the exception of purely transportational operations and the means required therefor, for example pipelines, valves, pumps, compressors, reservoirs. One example would be a pipeline leading directly from one to the other of the two regions.

A means is to be understood as meaning something that enables or is helpful in the achievement of a goal. In particular, means for performing a particular process step are to be understood as meaning any physical articles that would be considered by a person skilled in the art in order to be able to perform this process step. For example, a person skilled in the art will consider means of introducing or discharging a material stream to include any transporting and conveying apparatuses, i.e. for example pipelines, pumps, compressors, valves, which seem necessary or sensible to said skilled person for performance of this process step on the basis of his knowledge of the art.

For the purposes of this description, steam is to be understood as being synonymous with water vapor unless the opposite is indicated in an individual case. By contrast, the term “water” refers to water in a liquid state of matter unless otherwise stated in an individual case.

In the context of the present disclosure, a physical or chemical carbon dioxide separation process is understood to be a process that enables a fluid mixture, for example a gas mixture, to be separated into its components or undesirable components to be separated from this mixture by applying suitable physicochemical conditions, for example by phase transition such as condensation or by using a suitable sorbent. When a sorption process is used, it may be based on adsorption, i.e., binding of the substance or substances to be separated to a surface or interface of the solid adsorbent, or on absorption, i.e., uptake of the substance or substances to be separated into the volume of the liquid or solid adsorbent. The substance or substances separated and bound by means of sorption are referred to as adsorbate or absorbate. The binding forces acting in this process can be of a physical or chemical nature. Accordingly, weaker, non-specific binding forces, e.g. van der Waals forces, usually act in physical sorption, whereas stronger, more specific binding forces act in chemical sorption and the adsorbate and/or absorbent is chemically changed.

As synonyms for the term absorbent, in the case of liquid absorbents, the terms washing agent, solvent or scrubbing medium are used in the context of the present disclosure. Gas cleaning by such absorbent is also termed gas scrubbing.

A specific, physical absorption process is the gas scrubbing with chilled methanol, which uses methanol as absorbent or scrubbing agent, the temperature of which has been cooled by means of cold-generating processes below ambient temperature, preferably below 0° C., most preferably below −30° C. This process is known to the skilled person as the Rectisol process.

In contrast, the amine washes, which are known per se and frequently used for the absorption of carbon dioxide, are based on chemical absorption (chemisorption) and can also achieve high purities even at relatively low pressures in the absorption column.

In amine washing, slightly alkaline aqueous solutions of amines, often ethanolamine derivatives, are used in an absorption unit (absorption section) usually designed as a washing column. Absorption takes place at low temperature, e.g. 40° C., and slightly elevated pressure, e.g. 8 bara. Fresh or regenerated absorbent is fed at the top of the column and the gas stream to be separated is introduced in the lower section of the scrubbing column. In this process, carbon dioxide is reversibly chemically absorbed. The gas, which is depleted in carbon dioxide, leaves the column at the top and the loaded scrubbing agent is discharged at the bottom of the column and fed into a desorption section, which is also frequently designed as a separation column. In the desorption column (regeneration section), the reaction reverses the chemical equilibrium at a higher temperature and lower pressure, thus releasing the absorbed carbon dioxide as a gas. It can then be discharged at the head of the desorption column for further use or disposal. The absorbent regenerated in this way is returned to the absorption section.

An absorbent commonly used in amine scrubbing is methyldiethanolamine (MDEA), which is mostly used in aqueous solutions. In addition, activators, for example piperazine, are often added to accelerate carbon dioxide absorption, as described, for example, in the article “The Activator Mechanism of Piperazine in Aqueous Methyldiethanolamine Solutions,” J. Ying et al, Energy Procedia 114 (2017), pp. 2078-2087. These mixtures are then referred to as activated MDEA solutions (aMDEA).

In an alternative wording, a fine scrubbing medium, for example received from regeneration by heating the laden scrubbing medium (“hot regeneration”), is often designated as lean scrubbing medium, and a main or bulk scrubbing medium, for example received from regenerating the laden scrubbing medium by fast pressure decrease (“flash regeneration”), is often designated as semi-lean scrubbing medium.

According to a first aspect, the invention provides a process for producing a hydrogen-rich synthesis gas stream from a carbon-containing input gas stream having reduced carbon dioxide emission, comprising the steps of:
(a) providing a sulfur-free or desulfurized, carbon-containing input gas stream;
(b) introducing the input gas stream, preferably the sulfur-free or desulfurized input gas, into at least one synthesis gas production stage, selected from a group comprising steam reforming stage, gas-heated reforming stage (GHR), autothermal reforming stage (ATR), catalytic partial oxidation stage (CPOX), noncatalytic partial oxidation stage (POX);
(c) converting the carbon-containing input gas stream introduced into the at least one synthesis gas production stage under synthesis gas production conditions and discharging a raw synthesis gas stream containing hydrogen, carbon monoxide and carbon dioxide from the at least one synthesis gas production stage;
(d) introducing the raw synthesis gas stream into a first cooling apparatus, cooling the raw synthesis gas stream in the first cooling apparatus, discharging the cooled raw synthesis gas stream from the first cooling apparatus;
(e) introducing the cooled raw synthesis gas stream into a carbon monoxide (CO) conversion plant comprising at least one CO conversion stage, converting the cooled raw synthesis gas stream introduced into the CO conversion plant under CO conversion conditions to afford a converted synthesis gas stream, discharging the converted synthesis gas stream which is enriched in hydrogen and carbon dioxide and depleted in carbon monoxide relative to the raw synthesis gas stream;
(f) introducing the converted synthesis gas stream into a second cooling apparatus, cooling the converted the synthesis gas stream in the second cooling apparatus, discharging the cooled converted synthesis gas stream from the second cooling apparatus;
(g) introducing the cooled converted synthesis gas stream into a carbon dioxide absorption column, which operates according to the principle of a gas scrubbing having a physical or chemical scrubbing medium, wherein the carbon dioxide absorption column comprises:
   (g1) at least one mass transfer zone, in the form of a structured packing and/or a random packing and/or a tray column,
   (g2) an inlet for the cooled converted synthesis gas stream,
   (g3) an outlet for a first synthesis gas stream depleted in carbon dioxide at the upper end of the absorption column,
   (g4) an outlet for a scrubbing medium stream enriched in carbon dioxide at the lower end of the absorption column,
   (g5) an inlet for a fine scrubbing medium stream in the upper region of the absorption column, wherein the fine scrubbing medium stream is obtained by hot regeneration of at least a portion of the scrubbing medium stream enriched in carbon dioxide,
   (g6) an inlet for a main scrubbing medium stream arranged in the upper region of the absorption column but below the inlet for the fine scrubbing medium stream, wherein the main scrubbing medium stream is obtained by flash regeneration of at least a portion of the scrubbing medium stream enriched in carbon dioxide to obtain at least one flash gas stream whose carbon dioxide concentration is higher than that in the first synthesis gas stream depleted in carbon dioxide;
(h) contacting the cooled converted synthesis gas stream in the carbon dioxide absorption column with the main scrubbing medium stream and with the fine scrubbing medium stream, discharging the first synthesis gas stream depleted in carbon dioxide as a hydrogen-rich synthesis gas stream at the upper end of the absorption column;
(i) optionally supplying the hydrogen-rich synthesis gas stream to at least one further purifying, conditioning or processing step;
characterized in that
(j) the carbon dioxide absorption column comprises a further outlet which is arranged below the inlet for the fine scrubbing medium stream as a side draw and by means of which a second synthesis gas stream depleted in carbon dioxide, whose carbon dioxide concentration is higher than that in the first synthesis gas stream depleted in carbon dioxide, is discharged;
(k) wherein at least a portion of the second synthesis gas stream depleted in carbon dioxide is utilized as a portion of a fuel gas or process gas or forms the fuel gas or process gas.

The process for producing the hydrogen according to the invention is of advantage in that the process decreases the carbon emissions from reforming by using hydrogen fueling without consuming a high amount of energy for the purification of the hydrogen in the gas-cleaning unit. The process includes withdrawing a hydrogen rich fuel gas stream between the fine and bulk wash section or main wash section of the carbon dioxide absorption column and using it as hydrogen fuel within the reforming section through which the solvent requirement for the fine scrubbing section is reduced which in turn enables savings in electrical and low-pressure steam consumption, and enables decreasing diameters of both carbon dioxide absorption column and regenerator slightly. The process of the invention includes flash regeneration of the scrubbing media stream from the carbon dioxide absorption column to obtain the main scrubbing medium stream, where the regeneration is done by flashing (pressure decrease) and consumes only a minimum energy for re-compression of the solvent. During flashing, CO₂ is removed from the solvent and the so-called auto-refrigeration effect causes a decrease in the temperature of the system, which is beneficial for absorption efficiency. The process of the invention includes hot regeneration of the scrubbing media stream from the carbon dioxide absorption column to obtain the fine scrubbing medium stream. In the fine scrubbing section, a stream of cooled methanol from the hot regeneration unit is used for absorption. The regeneration of this type of solvent requires more energy and additional equipment than the solvent regenerated by flashing only. Therefore, reducing this type of solvent leads to savings in utility consumption and capital expenditures.

The hydrogen-rich synthesis gas stream and the second synthesis gas stream from the carbon dioxide absorption column is cold about <−20° C. as withdrawn from the carbon dioxide absorption column. The hydrogen-rich synthesis gas stream and the second synthesis gas stream may be routed through a Spiral-Wound Heat Exchanger (multi-fluid heat exchanger type), where the cold of both the first hydrogen-rich synthesis gas stream from the top of the carbon dioxide absorption column and the second synthesis gas stream from the side draw for the Hydrogen fuel are heated against the warm feed gas from the CO conversion plant.

Optionally, in addition to the at least a portion of the second synthesis gas stream depleted in carbon dioxide at least a portion of the at least one flash gas stream is also utilized as a portion of a fuel gas or process gas or forms the fuel gas or process gas. Optionally, other sources of hydrogen rich streams within the carbon dioxide absorption column are used. The advantage of taking a hydrogen stream from the high pressure (HP) and medium pressure (MP) recycle gas, which in an example are retrieved from the corresponding flash desorption stages, would be that the recycle gas compressor can be left out of the design and therefore capital expenditures for the machine as well as operating costs (electricity, cooling medium) can be saved.

Optionally, in addition to the at least a portion of the second synthesis gas stream depleted in carbon dioxide at least a portion of the at least one flash gas stream is also utilized as a portion of a fuel gas or process gas or forms the fuel gas or process gas. Optionally, a portion of the second synthesis gas is mixed with at least a portion of the first synthesis gas, and the mixed gas is used at least partially as a feed gas for chemical syntheses, in an example for methanol synthesis.

Optionally, at least a portion of the second synthesis gas is mixed with at least a portion of the first synthesis gas, and the mixed gas is used at least partially as a portion of a fuel gas or process gas or forms the fuel gas or process gas.

Optionally, at least a portion of the second synthesis gas stream depleted in carbon dioxide is utilized as a portion of a fuel gas or process gas in the synthesis gas production stage. This leads to further reductions of carbon emitted from the process.

Optionally, in addition at least a portion of the at least one flash gas stream is utilized as a portion of a fuel gas or process gas in the synthesis gas production stage. This leads to further reductions of carbon emitted from the process.

Optionally, the synthesis gas production stage is in the form of a steam reforming stage and comprises a multiplicity of reformer tubes filled with a solid, particulate reforming catalyst, the reformer tubes are arranged in a reformer furnace whose interior is heated by burning a fuel gas with oxygen and/or air to form a flue gas using a multiplicity of burners, the fuel gas comprises at least a portion of the second synthesis gas stream depleted in carbon dioxide. This leads to further reductions of carbon emitted from the process.

Optionally, the synthesis gas production stage is in the form of an autothermal reforming stage (ATR), catalytic partial oxidation stage (CPOX) or noncatalytic partial oxidation stage (POX), the input gas stream comprises at least a portion of the second synthesis gas stream depleted in carbon dioxide and/or the second synthesis gas stream depleted in carbon dioxide is at least partially used as fuel gas. This leads to further reductions of carbon emitted from the process.

Optionally, the synthesis gas production stage is in the form of a combination of a steam reforming stage and an autothermal reforming stage (ATR), gas-heated reforming stage (GHR), catalytic partial oxidation stage (CPOX) or noncatalytic partial oxidation stage (POX), the input gas stream comprises a portion of the second synthesis gas stream depleted in carbon dioxide and/or the second synthesis gas stream depleted in carbon dioxide is at least partially used as fuel gas. This leads to further reductions of carbon emitted from the process.

Optionally, the entire second synthesis gas stream depleted in carbon dioxide or the entire second synthesis gas stream depleted in carbon dioxide and the entire at least one flash gas stream is utilized as a portion of a fuel gas or process gas. This leads to further reductions of carbon emitted from the process.

Optionally, the scrubbing medium contains one or more components selected from the following group: methanol, N-methyl pyrrolidone (NMP), secondary amines, preferably diethanolamine, tertiary amines, preferably methyldiethanolamine, methyldiethanolamine with an activator, preferably methyldiethanolamine with piperazine, polyethylene glycol dialkyl ether, preferably polyethylene glycol dimethyl ether, ammonia solutions, preferably aqueous ammonia solutions.

Optionally, the side draw is arranged at least one theoretical plate, preferably at least two theoretical plates, most preferably at least three theoretical plates below the outlet for the first synthesis gas stream depleted in carbon dioxide.

Optionally, the side draw comprises a droplet separator.

Optionally, the second synthesis gas stream depleted in carbon dioxide is passed through an expansion turbine for recovery of compression energy before it is utilized as a portion of a fuel gas or process gas or forms the fuel gas or process gas.

Optionally, the side draw is arranged below the inlet for the main scrubbing medium stream.

Optionally, the carbon dioxide absorption column comprises two mass transfer zones arranged spaced apart on top of one another inside the carbon dioxide absorption column, the upper mass transfer zone serves the fine scrubbing and the lower mass transfer zone serves the main scrubbing, the inlet for the fine scrubbing medium stream is arranged above the upper mass transfer zone and the inlet for the main scrubbing medium stream is arranged between the two mass-transfer zones and the side draw for discharging the second synthesis gas stream depleted in carbon dioxide is arranged below the inlet for the fine scrubbing medium stream and above the inlet for the main scrubbing medium stream.

Optionally, the carbon dioxide absorption column comprises three mass transfer zones arranged spaced apart on top of one another inside the carbon dioxide absorption column, the upper mass transfer zone serves the fine scrubbing and the middle and the lower mass transfer zone serve the main scrubbing, the inlet for the fine scrubbing medium stream is arranged above the upper mass transfer zone and the inlet for the main scrubbing medium stream is arranged above the middle mass transfer zone and the side draw for discharging the second synthesis gas stream depleted in carbon dioxide is arranged in the region of the mass transfer zones for the main scrubbing, preferably in an intermediate space between the middle and the lower mass transfer zone.

Optionally, the carbon dioxide absorption column is divided into two sub-columns which are arranged on top of one another or preferably next to one another, one sub-column comprises at least one mass transfer zone for the fine scrubbing and the other sub-column comprises at least one mass transfer zone for the main scrubbing.

Optionally, the carbon dioxide concentration in the second synthesis gas stream depleted in carbon dioxide is between 0.5 and 15 mol %, preferably between 1 and 10 mol %, most preferably between 2 and 6 mol %.

Optionally, the ratio of the molar flows of the second synthesis gas stream depleted in carbon dioxide to the first synthesis gas stream depleted in carbon dioxide is between 0.5% and 30%, preferably between 1% and 20%.

Optionally, the ratio of the molar flows of the at least one flash gas stream to the second synthesis gas stream depleted in carbon dioxide is between 10% and 200%, preferably between 20% and 100%.

Optionally, the at least one further purifying, conditioning or processing step (60) comprises a pressure swing adsorption apparatus (PSA) and/or a liquid nitrogen scrubbing (LNW) stage and/or a cryogenic condensation stage, in each case at least one offgas stream is obtained and utilized as a portion of a fuel gas or process gas.

Optionally, the carbon dioxide absorption column comprises a further mass transfer zone which is arranged above a mass transfer zone for the fine scrubbing and serves for backwashing of the scrubbing medium from the first synthesis gas stream depleted in carbon dioxide.

According to a second aspect, the invention provides a plant for producing a hydrogen-rich synthesis gas stream from a carbon-containing input gas stream having reduced carbon dioxide emission, comprising the following assemblies and constituents fluidically connected to one another:
(a) means for providing a sulfur-free or desulfurized, carbon-containing input gas stream;
(b) at least one synthesis gas production stage selected from a group comprising:
steam reforming stage, gas-heated reforming stage (GHR), autothermal reforming stage (ATR), catalytic partial oxidation stage (CPOX), noncatalytic partial oxidation stage (POX);
means for introducing the input gas stream, preferably the sulfur-free or desulfurized input gas stream, into the at least one synthesis gas production stage;
(c) means for discharging a raw synthesis gas stream containing hydrogen, carbon monoxide (CO) and carbon dioxide (CO₂) from the at least one synthesis gas production stage;
(d) a first cooling apparatus, means for discharging the raw synthesis gas stream into the first cooling apparatus means for discharging a cooled raw synthesis gas stream from the cooling apparatus;
(e) a CO conversion plant comprising at least one CO conversion stage, means for introducing the cooled raw synthesis gas stream into the CO conversion plant, means for discharging a converted synthesis gas stream which is enriched in hydrogen and carbon dioxide and depleted in carbon monoxide relative to the raw synthesis gas stream;
(f) a second cooling apparatus, means for introducing the converted synthesis gas stream into the second cooling apparatus, means for discharging a cooled converted synthesis gas stream from the second cooling apparatus;
(g) a carbon dioxide absorption column which operates according to the principle of a gas scrubbing having a physical or chemical scrubbing medium, wherein the carbon dioxide absorption column comprises:
   (g1) at least one mass transfer zone in the form of a structured packing and/or a random packing and/or or a tray column,
   (g2) an inlet for the cooled converted synthesis gas stream,
   (g3) an outlet for a first synthesis gas stream depleted in carbon dioxide at the upper end of the absorption column,
   (g4) an outlet for a scrubbing medium stream enriched in carbon dioxide at the lower end of the absorption column,
   (g5) an inlet for a fine scrubbing medium stream in the upper region of the absorption column, wherein the fine scrubbing medium stream is obtained by hot regeneration of at least a portion of the scrubbing medium stream enriched in carbon dioxide,
   (g6) an inlet for a main scrubbing medium stream arranged in the upper region of the absorption column but below the inlet for the fine scrubbing medium stream, wherein the main scrubbing medium stream is obtained by flash regeneration of at least a portion of the scrubbing medium stream enriched in carbon dioxide, wherein at least one flash gas stream whose carbon dioxide concentration is higher than that in the first synthesis gas stream depleted in carbon dioxide is obtained, means for introducing the cooled converted synthesis gas stream into the carbon dioxide absorption column;
(h) means for discharging the first synthesis gas stream depleted in carbon dioxide as a hydrogen-rich synthesis gas stream at the upper end of the absorption column;
(i) optionally: means for supplying the hydrogen-rich synthesis gas stream to at least a further purification, conditioning or processing apparatus;
characterized in that
(j) the carbon dioxide absorption column comprises a further outlet which is arranged below the inlet for the fine scrubbing medium stream as a side draw and by means of which a second synthesis gas stream depleted in carbon dioxide, whose carbon dioxide concentration is higher than that in the first synthesis gas stream depleted in carbon dioxide, may be discharged;
(k) wherein means which allow at least a portion of the second synthesis gas stream depleted in carbon dioxide to be utilized as a portion of a fuel gas or process gas or to form the fuel gas or process gas are comprised.

The plant for producing the hydrogen-rich synthesis gas stream from the carbon-containing input gas stream having reduced carbon dioxide emission according to the invention is of advantage in that the plant decreases the carbon emissions from reforming by using hydrogen fueling without consuming a high amount of energy for the purification of the hydrogen in the gas cleaning unit. The hydrogen rich fuel gas stream is withdrawn between the fine scrubbing and the main scrubbing section of the carbon dioxide absorption column and uses it as hydrogen fuel within the reforming section through which the solvent requirement for the fine scrubbing section is reduced which in turn enables savings in electrical and low-pressure steam consumption, and enables decreasing diameters of both carbon dioxide absorption column and regenerator slightly. Flash regeneration of the scrubbing media stream from the carbon dioxide absorption column is performed to obtain the main scrubbing medium stream, where the regeneration is done by flashing (pressure decrease) and consumes only a minimum energy for re-compression of the solvent. During flashing, CO₂ is removed from the solvent and the so-called auto-refrigeration effect causes a decrease in the temperature of the system, which is beneficial for absorption efficiency. Hot regeneration of the scrubbing media stream from the carbon dioxide absorption column is performed to obtain the fine scrubbing medium stream. In the fine scrubbing section, a stream of cooled methanol from the hot regeneration unit is used for absorption. The regeneration of this type of solvent requires more energy and additional equipment than the solvent regenerated by flashing only. Therefore, reducing this type of solvent leads to savings in utility consumption and capital expenditures.

The final carbon dioxide depleted first synthesis gas stream may be further treated, for example, for trace component removal in a Liquid Nitrogen Wash, and then finally sent along with Nitrogen to an ammonia synthesis unit. In the case of using a Rectisol stage, the side-draw-off is taken from between the fine and bulk wash section. The fine wash section of the column is located at the upper part, the bulk wash section at the lower part. In the bulk wash section, a major part of CO₂ is absorbed by a cold methanol stream, which has a residual CO₂ loading. The regeneration is done by flashing (pressure decrease) and consumes only a little energy for re-compression of the solvent. During flashing, CO₂ is removed from the solvent and the so-called auto-refrigeration effect causes a decrease in the temperature of the system, which is beneficial for absorption efficiency. The fine wash section, however, is responsible for removing the residual parts of CO₂ down to a lower percentage down to ppm levels (10 ppm to >1 mole %). In this washing section, a stream of cooled methanol from the hot regeneration column is used for absorption. The regeneration of this type of solvent requires more energy and additional equipment than the solvent regenerated by flashing only. Therefore, reducing this type of solvent leads to savings in utility consumption and capital expenditures.

Table 1 illustrates two different applications with either fuel grade (Invention 1) or chemical grade H₂ production (Invention 2), also covering different total H₂ production capacities (240 kNm³/h in Invention 1 vs 490 kNm³/h in Invention 2). In both examples, the CO₂ content in the flue gas is adjusted to meet a value below or equal to 7%, to reach a certain low CO₂ content per unit amount of H₂ produced.

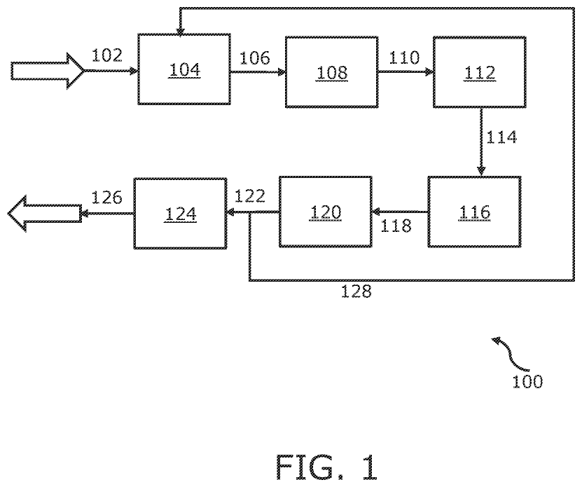

The second synthesis gas stream composition is 4.5% CO₂ and 93% H₂ (depending on e. g. reforming feed gas and reforming setup) and has only a slightly increased CO₂ content (>1% CO₂, 97% H₂) as compared to the H₂ fueling stream as described in the prior art (FIG. 1, stream (128)). The calculated results for both invention 1 and 2 and prior art (comparative examples 1 and 2) are obtained from a simulation using Aspen Plus and are given in Table 1.

The process of the present invention is not only applicable to physical absorption like the Rectisol process, but also for chemical absorption like amine wash technology, or other gas cleaning technologies known from the prior art, like the Selexol or Purisol processes.

TABLE 1

| | | Prior art 1 | Invention | Prior art 2 | Invention |
|---|---|---|---|---|---|
| Parameters | Unit | (comparative) | 1 | (comparative) | 2 |
| H₂ fueling | % of | 1.5% | 1.5% | 5.5% | 5.5% |
| | total | | | | |
| | H2 | | | | |
| CO₂ in flue | — | 5.8% | 6.4% | 6.7% | 7.0% |
| gas | | | | | |
| Electricity | — | 100% | 99.8% | 100% | 99.0% |
| consumption | | | | | |
| absorber | | | | | |
| LP steam | — | 100% | 98.7% | 100% | 92.9% |
| consumption | | | | | |
| absorber | | | | | |
| Absorber | — | 100% | 99% | 100% | 98% |
| diameter | | | | | |
| Regenerator | — | 100% | 99% | 100% | 97% |
| diameter | | | | | |

The process of the invention may also be applied in hydrogen production setups as well, not only in ammonia production. The process of the invention may also be applied in fuel grade as well as chemical grade hydrogen production setups. The process of the invention may also be applied in methanol-ammonia co-production plants.

The setup according to the invention can be applied downstream of autothermal reforming, partial oxidation, gas-heated reforming or “two step” reforming (steam methane reformer with downstream air blown ATR, which are typically used for ammonia production), as well as any setup considering an electrolysis integration.

Embodiments of the invention substantially eliminate or at least partially address the aforementioned technical drawbacks in existing technologies for decreasing the carbon emissions from reforming by using hydrogen fueling without using too much energy for the purification of the hydrogen in the gas-cleaning unit.

FIG. 1 is a block diagram of a prior art plant 100 for producing hydrogen-rich synthesis gas stream from a carbon-containing input gas stream 102. The plant 100 comprises a sulfur-free or desulfurized, carbon-containing input gas stream providing means, a synthesis gas production stage 104, an input gas stream introducing means, a raw synthesis gas stream discharging means, a first cooling apparatus 108, a raw synthesis gas stream introducing means, a cooled raw synthesis gas stream discharging means, a carbon monoxide (CO) conversion plant 112, a cooled raw synthesis gas stream introducing means, a converted synthesis gas stream discharging means, a second cooling apparatus 116, a converted synthesis gas stream introducing means, a cooled converted synthesis gas stream discharging means, a carbon dioxide absorption column 120, a cooled converted synthesis gas stream inlet, a first synthesis gas stream discharging means, a purification, conditioning or processing apparatus 124, a first synthesis gas stream supplying means, a purified, conditioned or processed synthesis gas stream discharging means, and a second synthesis gas stream supplying means. The hydrogen-rich synthesis gas stream from the carbon-containing input gas stream is produced by providing a sulfur-free or desulfurized, carbon-containing input gas stream 102 from the carbon-containing input gas stream providing means. The carbon-containing input gas stream, preferably the sulfur-free or desulfurized input gas stream 102 is introduced into the at least one synthesis gas production stage 104 through the input gas stream introducing means. The at least one synthesis gas production stage 104 is selected from a group comprising steam reforming stage, gas-heated reforming stage (GHR), autothermal reforming stage (ATR), catalytic partial oxidation stage (CPOX), noncatalytic partial oxidation stage (POX). The carbon-containing input gas stream 102 is converted into a raw synthesis gas stream 106 containing hydrogen, carbon monoxide (CO) and carbon dioxide (CO2) under synthesis gas production conditions in the at least one synthesis gas production stage 104. The raw synthesis gas stream 106 is discharged from the at least one synthesis gas production stage 104 through the raw synthesis gas stream discharging means. The raw synthesis gas stream 106 is introduced into the first cooling apparatus 108 through the raw synthesis gas stream introducing means for cooling. The cooled raw synthesis gas stream 110 is discharged from the first cooling apparatus 108 through the cooled raw synthesis gas stream discharging means. The cooled raw synthesis gas stream 110 is introduced into the CO conversion plant 112 through the cooled raw synthesis gas stream introducing means. The CO conversion plant 112 comprises at least one CO conversion stage (CO shift stage) for converting the cooled raw synthesis gas stream 110 introduced into the CO conversion plant 112 under CO conversion conditions to afford a converted synthesis gas stream 114. The converted synthesis gas stream 114 which is enriched in hydrogen and carbon dioxide and depleted in carbon monoxide relative to the raw synthesis gas stream 106 is discharged from the CO conversion plant 112 through the converted synthesis gas stream discharging means. The converted synthesis gas stream 114 is introduced into the second cooling apparatus 116 through the converted synthesis gas stream introducing means for cooling. The cooled converted synthesis gas stream 118 is discharged from the second cooling apparatus 116 through the cooled converted synthesis gas stream discharging means. The cooled converted synthesis gas stream 118 is introduced into the carbon dioxide absorption column 120 through the cooled converted synthesis gas stream inlet. The carbon dioxide absorption column 120 operates according to the principle of a gas scrubbing having a physical or chemical scrubbing medium. A first synthesis gas stream 122 depleted in carbon dioxide is discharged as a hydrogen-rich synthesis gas stream at an upper end of the absorption column 120 through the first synthesis gas stream discharging means. Further, a carbon dioxide rich gas stream is discharged from the absorption column 120 through a carbon dioxide rich gas stream discharging means (not shown). The first synthesis gas stream 122 is optionally supplied to the at least one further purifying, conditioning or processing apparatus 124 through the hydrogen-rich synthesis gas stream supplying means and a purified, conditioned or processed hydrogen-rich synthesis gas stream 126 is discharged through the purified, conditioned or processed synthesis gas stream discharging means. At least a portion of the first synthesis gas stream 122 depleted in carbon dioxide and having the same composition as 122, is branched off as stream 128, recycled and utilized as a portion of a fuel gas or process gas or forms the fuel gas in the synthesis gas production stage 104.

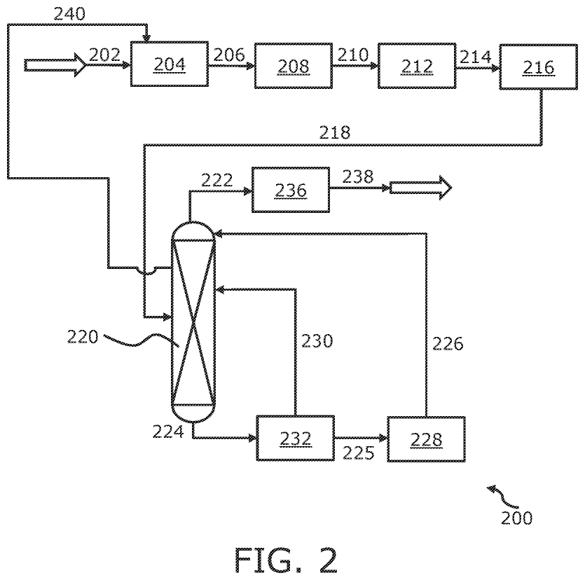

FIG. 2 is a block diagram of a plant 200 for producing a hydrogen rich synthesis gas stream from a carbon-containing input gas stream having reduced carbon dioxide emission by utilizing at least a portion of a second synthesis gas stream depleted in carbon dioxide as a portion of a fuel gas or process gas or forms the fuel gas or process gas in a synthesis gas production stage 204 according to an embodiment of the present disclosure. The plant 200 comprises a sulfur-free or desulfurized, carbon-containing input gas stream providing means, at least one synthesis gas production stage 204, an input gas stream introducing means, a raw synthesis gas stream discharging means, a first cooling apparatus 208, a raw synthesis gas stream introducing means, a cooled raw synthesis gas stream discharging means, a carbon monoxide (CO) conversion (CO shift) plant 212, a cooled raw synthesis gas stream introducing means, a converted synthesis gas stream discharging means, a second cooling apparatus 216, a converted synthesis gas stream introducing means, a cooled converted synthesis gas stream discharging means, a carbon dioxide absorption column 220, a cooled converted synthesis gas stream inlet, a first synthesis gas stream outlet, a scrubbing medium stream outlet, a fine scrubbing medium stream inlet, a hot regeneration unit 228, a main scrubbing medium stream inlet, a flash regeneration unit 232, a purification, conditioning or processing apparatus 236, a hydrogen-rich synthesis gas stream supplying means, a purified, conditioned or processed hydrogen-rich synthesis gas stream discharging means, a second synthesis gas stream outlet. The hydrogen-rich synthesis gas stream is produced by providing a sulfur-free or desulfurized, carbon-containing input gas stream 202. The carbon-containing input gas stream 202, preferably the sulfur-free or desulfurized input gas stream is introduced into the at least one synthesis gas production stage 204 through the input gas stream introducing means. The at least one synthesis gas production stage 204 is selected from a group comprising steam reforming stage, gas-heated reforming stage (GHR), autothermal reforming stage (ATR), catalytic partial oxidation stage (CPOX), noncatalytic partial oxidation stage (POX). The carbon-containing input gas stream 202 is converted into a raw synthesis gas stream 206 containing hydrogen, carbon monoxide (CO) and carbon dioxide (CO2) under synthesis gas production conditions in the at least one synthesis gas production stage 204. The raw synthesis gas stream 206 is discharged from the at least one synthesis gas production stage 204 through the raw synthesis gas stream discharging means. The raw synthesis gas stream 206 is introduced into the first cooling apparatus 208 through the raw synthesis gas stream introducing means for cooling. The cooled raw synthesis gas stream 210 is discharged from the first cooling apparatus 208 through the cooled raw synthesis gas stream discharging means. The cooled raw synthesis gas stream 210 is introduced into the CO conversion plant 212 through the cooled raw synthesis gas stream introducing means. The CO conversion plant 212 comprises at least one CO conversion stage (CO shift stage) for converting the cooled raw synthesis gas stream 210 introduced into the CO conversion plant 212 under CO conversion conditions to afford a converted synthesis gas stream 214. The converted synthesis gas stream 214 which is enriched in hydrogen and carbon dioxide and depleted in carbon monoxide relative to the raw synthesis gas stream 206 is discharged from the CO conversion plant 212 through the converted synthesis gas stream discharging means. The converted synthesis gas stream 214 is introduced into the second cooling apparatus 216 through the converted synthesis gas stream introducing means for cooling. The cooled converted synthesis gas stream 218 is discharged from the second cooling apparatus 216 through the cooled converted synthesis gas stream discharging means. The cooled converted synthesis gas stream 218 is introduced into the carbon dioxide absorption column 220 through the cooled converted synthesis gas stream inlet. The carbon dioxide absorption column 220 operates according to the principle of a gas scrubbing, employing a physical or chemical scrubbing medium. The carbon dioxide absorption column 220 comprises at least one mass transfer zone, in a form of a structured packing and/or a random packing and/or a tray column, the cooled converted synthesis gas stream inlet, the first synthesis gas stream outlet at an upper end of the carbon dioxide absorption column 220, the scrubbing medium stream outlet at a lower end of the carbon dioxide absorption column 220, the fine scrubbing medium stream inlet in an upper region of the absorption column 220 and the main scrubbing medium stream inlet arranged in an upper region of the carbon dioxide absorption column 220 but below the inlet for the fine scrubbing medium stream 226. The main scrubbing medium stream 230 is obtained by flash regeneration of at least a portion of the laden scrubbing medium stream 224 enriched in carbon dioxide in the flash regeneration unit 232 to obtain at least one flash gas stream (not shown) whose carbon dioxide concentration is higher than that in the first synthesis gas stream 222 depleted in carbon dioxide, and to obtain a partially regenerated scrubbing medium stream 225. The fine scrubbing medium stream 226 is obtained by hot regeneration of at least a portion of the partially regenerated scrubbing medium stream 225 in the hot regeneration unit 228. Further, the hot regeneration affords at least one hot generation offgas stream (not shown) whose carbon dioxide concentration is higher than that in the first synthesis gas stream 222 depleted in carbon dioxide. The cooled converted synthesis gas stream 218 in the carbon dioxide absorption column 220 is contacted with the main scrubbing medium stream 230 and with the fine scrubbing medium stream 226 and the first synthesis gas stream 222 depleted in carbon dioxide is discharged as a hydrogen-rich synthesis gas stream at the upper end of the carbon dioxide absorption column 220. The hydrogen-rich synthesis gas stream 222 is optionally supplied to the at least one further purifying, conditioning or processing apparatus 236 through the hydrogen-rich synthesis gas stream supplying means and a purified, conditioned or processed hydrogen-rich synthesis gas stream 238 is discharged through the purified, conditioned or processed hydrogen-rich synthesis gas discharging means. According to an embodiment of the invention, the carbon dioxide absorption column 220 comprises the second synthesis gas stream outlet which is arranged below the inlet for the fine scrubbing medium stream 226 as a side draw and by means of which a second synthesis gas stream 240 depleted in carbon dioxide, whose carbon dioxide concentration is higher than that in the first synthesis gas stream 222, is discharged. At least a portion of the second synthesis gas stream 240 depleted in carbon dioxide is utilized as a portion of a fuel gas or process gas or forms the fuel gas or process gas in the synthesis gas production stage 204 through the second synthesis gas stream outlet.

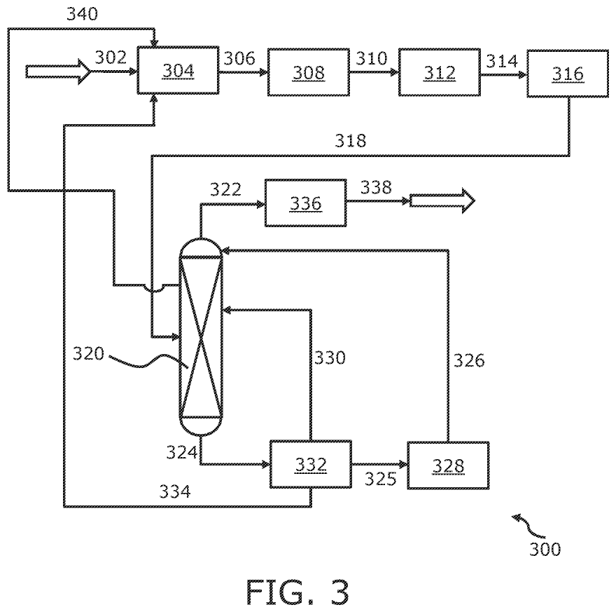

FIG. 3 is a block diagram of a plant 300 for producing a hydrogen rich synthesis gas stream from a carbon-containing input gas stream having reduced carbon dioxide emission by utilizing at least a portion of a second synthesis gas stream depleted in carbon dioxide in addition with at least a portion of at least one flash gas stream as a portion of a fuel gas or process gas or forms the fuel gas or process gas in a synthesis gas production stage 304 according to an embodiment of the present disclosure. The plant 300 comprises a sulfur-free or desulfurized, carbon-containing input gas stream providing means, at least one synthesis gas production stage 304, an input gas stream introducing means, a raw synthesis gas stream discharging means, a first cooling apparatus 308, a raw synthesis gas stream introducing means, a cooled raw synthesis gas stream discharging means, a carbon monoxide (CO) conversion (CO shift) plant 312, a cooled raw synthesis gas stream introducing means, a converted synthesis gas stream discharging means, a second cooling apparatus 316, a converted synthesis gas stream introducing means, a cooled converted synthesis gas stream discharging means, a carbon dioxide absorption column 320, a cooled converted synthesis gas stream inlet, a first synthesis gas stream outlet, a scrubbing medium stream outlet, a fine scrubbing medium stream inlet, a hot regeneration unit 328, a main scrubbing medium stream inlet, a flash regeneration unit 332, a purification, conditioning or processing apparatus 336, a first synthesis gas stream supplying means, a purified, conditioned or processed hydrogen-rich synthesis gas stream discharging means, a second synthesis gas stream outlet, at least one flash gas stream outlet. The hydrogen-rich synthesis gas stream is produced by providing a sulfur-free or desulfurized, carbon-containing input gas stream 302. The input gas stream 302, preferably the sulfur-free or desulfurized input gas is introduced into the at least one synthesis gas production stage 304 through the input gas stream-introducing means. The at least one synthesis gas production stage 304 is selected from a group comprising steam reforming stage, gas-heated reforming stage (GHR), autothermal reforming stage (ATR), catalytic partial oxidation stage (CPOX), noncatalytic partial oxidation stage (POX). The carbon-containing input gas stream 302 is introduced into the at least one synthesis gas production stage 304 through the input gas stream introducing means. The carbon-containing input gas stream 302 is converted into a raw synthesis gas stream 306 containing hydrogen, carbon monoxide (CO) and carbon dioxide (CO2) under synthesis gas production conditions in the at least one synthesis gas production stage 304. The raw synthesis gas stream 306 is discharged from the at least one synthesis gas production stage 304 through the raw synthesis gas stream discharging means. The raw synthesis gas stream 306 is introduced into the first cooling apparatus 308 through the raw synthesis gas stream introducing means for cooling. The cooled raw synthesis gas stream 310 is discharged from the first cooling apparatus 308 through the cooled raw synthesis gas stream discharging means. The cooled raw synthesis gas stream 306 is introduced into the CO conversion plant 312 through the cooled raw synthesis gas stream introducing means. The CO conversion plant 312 comprises at least one CO conversion stage (CO shift stage) for converting the cooled raw synthesis gas stream 310 introduced into the CO conversion plant 312 under CO conversion conditions to afford a converted synthesis gas stream 314. The converted synthesis gas stream 314 which is enriched in hydrogen and carbon dioxide and depleted in carbon monoxide relative to the raw synthesis gas stream 306 is discharged from the CO conversion plant 312 through the converted synthesis gas stream discharging means. The converted synthesis gas stream 314 is introduced into the second cooling apparatus 316 through the converted synthesis gas stream introducing means for cooling. The cooled converted synthesis gas stream 318 is discharged from the second cooling apparatus 316 through the cooled converted synthesis gas stream discharging means. The cooled converted synthesis gas stream 318 is introduced into the carbon dioxide absorption column 320 through the cooled converted synthesis gas stream inlet. The carbon dioxide absorption column 320 operates according to the principle of a gas scrubbing, employing a physical or chemical scrubbing medium. The carbon dioxide absorption column 320 comprises at least one mass transfer zone, in the form of a structured packing and/or a random packing and/or a tray column, the cooled converted synthesis gas stream inlet, the first synthesis gas stream outlet at the upper end of the absorption column 320, the scrubbing medium stream outlet at the lower end of the absorption column 320, the fine scrubbing medium stream inlet in the upper region of the absorption column 320 and the main scrubbing medium stream inlet arranged in the upper region of the carbon dioxide absorption column 320 but below the inlet for the fine scrubbing medium stream 326. The main scrubbing medium stream 330 is obtained by flash regeneration of at least a portion of the laden scrubbing medium stream 324 enriched in carbon dioxide in the flash regeneration unit 332 to obtain at least one flash gas stream 334 whose carbon dioxide concentration is higher than that in the first synthesis gas stream 322 depleted in carbon dioxide, and to obtain a partially regenerated scrubbing medium stream 325. The fine scrubbing medium stream 326 is obtained by hot regeneration of at least a portion of the partially regenerated scrubbing medium stream 325 in the hot regeneration unit 328. Further, the hot regeneration affords at least one hot generation offgas stream (not shown) whose carbon dioxide concentration is higher than that in the first synthesis gas stream 322 depleted in carbon dioxide. The cooled converted synthesis gas stream 318 in the carbon dioxide absorption column 320 is contacted with the main scrubbing medium stream 330 and with the fine scrubbing medium stream 326 and the first synthesis gas stream 322 depleted in carbon dioxide is discharged as a hydrogen-rich synthesis gas stream at the upper end of the absorption column 320. The hydrogen-rich synthesis gas stream 322 is optionally supplied to the at least one further purifying, conditioning or processing step in the purification, conditioning or processing apparatus 336 through the hydrogen-rich synthesis gas stream supplying means and a purified, conditioned or processed hydrogen-rich synthesis gas stream 338 is discharged through the purified, conditioned or processed hydrogen-rich synthesis gas stream discharging means. According to an embodiment of the invention, the carbon dioxide absorption column 320 comprises the second synthesis gas stream outlet which is arranged below the inlet for the fine scrubbing medium stream 326 as a side draw and by means of which the second synthesis gas stream 340 depleted in carbon dioxide, whose carbon dioxide concentration is higher than that in the first synthesis gas stream 322 depleted in carbon dioxide, is discharged. At least a portion of the second synthesis gas stream 340 depleted in carbon dioxide is utilized as a portion of a fuel gas or process gas or forms the fuel gas or process gas in a synthesis gas production stage 304 through the second synthesis gas stream outlet. In addition, at least a portion of the at least one flash gas stream 334 is utilized as a portion of a fuel gas or process gas in the synthesis gas production stage 304 through the at least one flash gas stream outlet.

Modifications to embodiments of the invention described in the foregoing are possible without departing from the scope of the invention as defined by the accompanying claims. Expressions such as “including”, “comprising”, “incorporating”, “have”, “is” used to describe, and claim the invention are intended to be construed in a non-exclusive manner, namely allowing for items, components or elements not explicitly described also to be present. Reference to the singular is also to be construed to relate to the plural.

### LIST OF REFERENCE NUMERALS

100, 200, 300 plant
102, 202, 302 carbon containing input gas stream
104, 204, 304 at least one synthesis gas production stage
106, 206, 306 raw synthesis gas stream
108, 208, 308 first cooling apparatus
110, 210, 310 cooled raw synthesis gas stream
112, 212, 312 CO conversion plant (CO shift plant)
114, 214, 314 converted synthesis gas stream
116, 216, 316 second cooling apparatus
118, 218, 318 cooled converted synthesis gas stream
120, 220, 320 carbon dioxide absorption column
122, 222, 322 first synthesis gas stream or hydrogen-rich synthesis gas stream
124, 236, 336 purifying, conditioning or processing apparatus or step
126, 238, 338 purified, conditioned or processed hydrogen-rich synthesis gas stream
224, 324 laden scrubbing medium stream
225, 325 partially regenerated scrubbing medium stream
226, 326 fine (lean) scrubbing medium stream
228, 328 hot regeneration unit
230, 330 main (semi-lean) scrubbing medium stream
232, 332 flash regeneration unit
334 at least one flash gas stream
240 second synthesis gas stream

What is claimed is:

1. A process for producing a hydrogen-rich synthesis gas stream from a carbon-containing input gas stream having reduced carbon dioxide emission, comprising:
(a) providing a sulfur-free or desulfurized, carbon-containing input gas stream;
(b) introducing the carbon-containing input gas stream into at least one synthesis gas production stage selected from a group consisting of:
a steam reforming stage, a gas-heated reforming stage (GHR), an autothermal reforming stage (ATR), a catalytic partial oxidation stage (CPOX), and a noncatalytic partial oxidation stage (POX);
(c) converting the carbon-containing input gas stream introduced into the at least one synthesis gas production stage under synthesis gas production conditions and discharging a raw synthesis gas stream containing hydrogen, carbon monoxide and carbon dioxide from the at least one synthesis gas production stage;
(d) introducing the raw synthesis gas stream into a first cooling apparatus, cooling the raw synthesis gas stream in the first cooling apparatus, discharging the cooled raw synthesis gas stream from the first cooling apparatus;
(e) introducing the cooled raw synthesis gas stream into a CO conversion plant comprising at least one CO conversion stage, converting the cooled raw synthesis gas stream introduced into the CO conversion plant under CO conversion conditions to afford a converted synthesis gas stream, discharging the converted synthesis gas stream which is enriched in hydrogen and carbon dioxide and depleted in carbon monoxide relative to the raw synthesis gas stream;
(f) introducing the converted synthesis gas stream into a second cooling apparatus, cooling the converted the synthesis gas stream in the second cooling apparatus, discharging the cooled converted synthesis gas stream from the second cooling apparatus;
(g) introducing the cooled converted synthesis gas stream into a carbon dioxide absorption column which operates according to the principle of a gas scrubbing having a physical or chemical scrubbing medium, wherein the carbon dioxide absorption column comprises:
(g1) at least one mass transfer zone, in the form of a structured packing and/or a random packing and/or a tray column,
(g2) an inlet for the cooled converted synthesis gas stream,
(g3) an outlet for a first synthesis gas stream depleted in carbon dioxide at the upper end of the absorption column,
(g4) an outlet for a scrubbing medium stream enriched in carbon dioxide at the lower end of the absorption column,
(g5) an inlet for a fine scrubbing medium stream
in the upper region of the absorption column, wherein the fine scrubbing medium stream is obtained by hot regeneration of at least a portion of the scrubbing medium stream enriched in carbon dioxide,
(g6) an inlet for a main scrubbing medium stream arranged in the upper region of the absorption column but below the inlet for the fine scrubbing medium stream, wherein the main scrubbing medium stream is obtained by flash regeneration of at least a portion of the scrubbing medium stream enriched in carbon dioxide to obtain least one flash gas stream whose carbon dioxide concentration is higher than that in the first synthesis gas stream depleted in carbon dioxide;
(h) contacting the cooled converted synthesis gas stream in the carbon dioxide absorption column with the main scrubbing medium stream and with the fine scrubbing medium stream, discharging the first synthesis gas stream depleted in carbon dioxide as a hydrogen-rich synthesis gas stream at the upper end of the absorption column;
(i) supplying the hydrogen-rich synthesis gas stream to at least one further purifying, conditioning or processing step;
wherein,
(j) the carbon dioxide absorption column comprises a further outlet which is arranged below the inlet for the fine scrubbing medium stream as a side draw and by means of which a second synthesis gas stream depleted in carbon dioxide, whose carbon dioxide concentration is higher than that in the first synthesis gas stream depleted in carbon dioxide, is discharged;
(k) wherein at least a portion of the second synthesis gas stream depleted in carbon dioxide is utilized as a portion of a fuel gas or process gas or forms the fuel gas or process gas.

2. The process according to claim 1, wherein, in addition to the at least a portion of the second synthesis gas stream depleted in carbon dioxide at least a portion of the at least one flash gas stream is also utilized as a portion of a fuel gas or process gas or forms the fuel gas or process gas.

3. The process according to claim 1, wherein at least a portion of the second synthesis gas stream depleted in carbon dioxide is utilized as a portion of a fuel gas or process gas in the synthesis gas production stage.

4. The process according to claim 1, wherein, in addition at least a portion of the at least one flash gas stream is utilized as a portion of a fuel gas or process gas in the synthesis gas production stage.

5. The process according to claim 1, wherein the synthesis gas production stage is in the form of a steam reforming stage and comprises a multiplicity of reformer tubes filled with a solid, particulate reforming catalyst, wherein the reformer tubes are arranged in a reformer furnace whose interior is heated by burning a fuel gas with oxygen and/or air to form a flue gas using a multiplicity of burners, wherein the fuel gas comprises at least a portion of the second synthesis gas stream depleted in carbon dioxide.

6. The process according to claim 1, wherein the synthesis gas production stage is in the form of an autothermal reforming stage (ATR), catalytic partial oxidation stage (CPOX) or noncatalytic partial oxidation stage (POX), wherein the input gas stream comprises at least a portion of the second synthesis gas stream depleted in carbon dioxide and/or the second synthesis gas stream depleted in carbon dioxide is at least partially used as fuel gas.

7. The process according to claim 1, wherein the synthesis gas production stage is in the form of a combination of a steam reforming stage and an autothermal reforming stage (ATR), catalytic partial oxidation stage (CPOX) or noncatalytic partial oxidation stage (POX), wherein the input gas stream comprises a portion of the second synthesis gas stream depleted in carbon dioxide and/or the second synthesis gas stream depleted in carbon dioxide is at least partially used as fuel gas.

8. The process according to claim 1, wherein the entire second synthesis gas stream depleted in carbon dioxide or the entire second synthesis gas stream depleted in carbon dioxide and the entire at least one flash gas stream is utilized as a portion of a fuel gas or process gas.

9. The process according to claim 1, wherein the scrubbing medium contains one or more components selected from the following group: methanol, N-methyl pyrrolidone (NMP), secondary amines, tertiary amines, methyldiethanolamine with an activator, polyethylene glycol dialkyl ether, and ammonia solutions.

10. The process according to claim 1, wherein the side draw is arranged at least one theoretical plate below the outlet for the first synthesis gas stream depleted in carbon dioxide.

11. The process according to claim 1, wherein the side draw comprises a droplet separator.

12. The process according to claim 1, wherein the second synthesis gas stream depleted in carbon dioxide is passed through an expansion turbine for recovery of compression energy before it is utilized as a portion of a fuel gas or process gas or forms the fuel gas or process gas.

13. The process according to claim 1, wherein the side draw is arranged below the inlet for the main scrubbing medium stream.

14. The process according to claim 1, wherein the carbon dioxide absorption column comprises two mass transfer zones arranged spaced apart on top of one another inside the carbon dioxide absorption column, wherein the upper mass transfer zone serves the fine scrubbing and the lower mass transfer zone serves the main scrubbing,
wherein the inlet for the fine scrubbing medium stream is arranged above the upper mass transfer zone and the inlet for the main scrubbing medium stream is arranged between the two mass-transfer zones and
wherein the side draw for discharging the second synthesis gas stream depleted in carbon dioxide is arranged below the inlet for the fine scrubbing medium stream and above the inlet for the main scrubbing medium stream.

15. The process according to claim 1, wherein the carbon dioxide absorption column comprises three mass transfer zones arranged spaced apart on top of one another inside the carbon dioxide absorption column, wherein the upper mass transfer zone serves the fine scrubbing and the middle and the lower mass transfer zone serve the main scrubbing,
wherein the inlet for the fine scrubbing medium stream is arranged above the upper mass transfer zone and the inlet for the main scrubbing medium stream is arranged above the middle mass transfer zone and
wherein the side draw for discharging the second synthesis gas stream depleted in carbon dioxide is arranged in the region of the mass transfer zones for the main scrubbing, preferably in an intermediate space between the middle and the lower mass transfer zone.

16. The process according to claim 1, wherein the carbon dioxide absorption column is divided into two sub-columns which are arranged on top of one another, wherein one sub-column comprises at least one mass transfer zone for the fine scrubbing and the other sub-column comprises at least one mass transfer zone for the main scrubbing.

17. The process according to claim 1, wherein the carbon dioxide concentration in the second synthesis gas stream depleted in carbon dioxide is between 0.5 and 15 mol %.

18. The process according to claim 1, wherein the ratio of the molar flows of the second synthesis gas stream depleted in carbon dioxide to the first synthesis gas stream depleted in carbon dioxide is between 0.5% and 30%.

19. The process according to claim 1, wherein the ratio of the molar flows of the at least one flash gas stream to the second synthesis gas stream depleted in carbon dioxide is between 10% and 200%.

20. The process according to claim 1, wherein the at least one further purifying, conditioning or processing step comprises a pressure swing adsorption apparatus (PSA) or a liquid nitrogen scrubbing (LNW) stage and/or a cryogenic condensation stage, wherein in each case at least one offgas stream is obtained and utilized as a portion of a fuel gas or process gas.
